(19) United States
(12) Patent Application Publication
(10) Pub. No.: US 2026/0205203 A1
(43) Pub. Date: Jul. 16, 2026

(54) ANTENNA-INTEGRATED ELECTRO-OPTIC MODULATOR

(71) Applicant: Murata Manufacturing Co., Ltd., Nagaokakyo-shi (JP)

(72) Inventor: Tsubasa NISHIDA, Nagaokakyo-shi (JP)

(73) Assignee: Murata Manufacturing Co., Ltd., Nagaokakyo-shi (JP)

(21) Appl. No.: 19/562,874

(22) Filed: Mar. 11, 2026

Related U.S. Application Data
(63) Continuation of application No. PCT/JP2024/042993, filed on Dec. 5, 2024.

(30) Foreign Application Priority Data
Jan. 24, 2024 (JP) 2024-008559

(51) Int. Cl. H04B 10/516

(52) U.S. Cl. CPC H04B 10/516

(57) ABSTRACT

An antenna-integrated electro-optic modulator including an optical waveguide configured to transmit an optical signal; a plurality of antenna electrodes configured to receive a radio signal for modulating the optical signal by an electro-optic effect; and an interface configured to provide different DC bias voltages to individual antenna electrodes of the plurality of antenna electrodes to control a reception direction of the radio signal.

### CROSS-REFERENCE TO RELATED APPLICATIONS

The present application is a continuation application of International Application No. PCT/JP2024/042993, filed on Dec. 5, 2024, which claims priority to Japanese Patent Application No. 2024-008559, filed on Jan. 24, 2024. The entire contents of these applications are incorporated herein by reference.

### TECHNICAL FIELD

The present disclosure relates to an antenna-integrated electro-optic modulator.

### BACKGROUND ART

Patent Document 1 discloses a radio signal reception and separation device that converts a plurality of radio signals into an optical signal by an electro-optic modulation effect and separates them, the radio signal reception and separation device including a plurality of optical waveguides that transmit the optical signal, an antenna that receives a plurality of the radio signals, and a plurality of modulation electrodes connected to the antenna, in which a plurality of the modulation electrodes are arranged close to each of a plurality of the optical waveguides so that the optical signal is modulated with the radio signal, and each of a plurality of the optical waveguides has a polarization inversion structure of a constant period in a propagation direction of the optical signal and has polarization inversion periods different from each other.

### PRIOR ART DOCUMENT

### Patent Document

Patent Document 1: Japanese Patent Application Laid-Open No. 2009-60183

### SUMMARY

Embodiments are directed to an antenna-integrated electro-optic modulator including an optical waveguide configured to transmit an optical signal, a plurality of antenna electrodes configured to receive a radio signal for modulating the optical signal by an electro-optic effect, and an interface configured to provide different DC bias voltages to individual antenna electrodes of the plurality of antenna electrodes to control a reception direction of the radio signal.

In a first aspect, an antenna-integrated electro-optic modulator includes: an optical waveguide that transmits an optical signal; a plurality of antenna electrodes that receive a radio signal for modulating the optical signal by an electro-optic effect; and a voltage circuit for applying different DC voltages to the antenna electrodes.

In a second aspect, an antenna-integrated electro-optic modulator includes: an optical waveguide that transmits an optical signal; a plurality of antenna electrodes that receive a radio signal for modulating the optical signal by an electro-optic effect; a plurality of external connection terminals for receiving different DC voltages; and a plurality of wirings that connect the external connection terminals and the antenna electrodes.

### BRIEF EXPLANATION OF DRAWINGS

FIG. 1 is a schematic view illustrating an example of an antenna-integrated electro-optic modulator of the present disclosure.

FIG. 2 is a plan view illustrating a part of the antenna-integrated electro-optic modulator illustrated in FIG. 1.

FIG. 3 is a plan view schematically illustrating an example of electrode arrangement in an antenna-integrated electro-optic modulator according to an example within the scope of the present disclosure.

FIG. 4 is an enlarged view of an antenna electrode in FIG. 3.

FIG. 5 is an example of angle dependence of reception sensitivity in a case where no DC voltage is applied to the antenna electrode.

FIG. 6 is an example of the angle dependence of the reception sensitivity in a case where a DC voltage is applied to the antenna electrode.

### DETAILED DESCRIPTION

In the radio signal reception and separation device described in Patent Document 1, each of a plurality of optical waveguides having polarization inversion period structures different from each other can detect only a radio signal having an incident angle or frequency identified by a polarization inversion period.

However, the inventor has realized that, in the radio signal reception and separation device described in Patent Document 1, one optical waveguide is required to acquire one beam. Therefore, in order to acquire a plurality of beams, the number of optical waveguides increases and the structure becomes complicated.

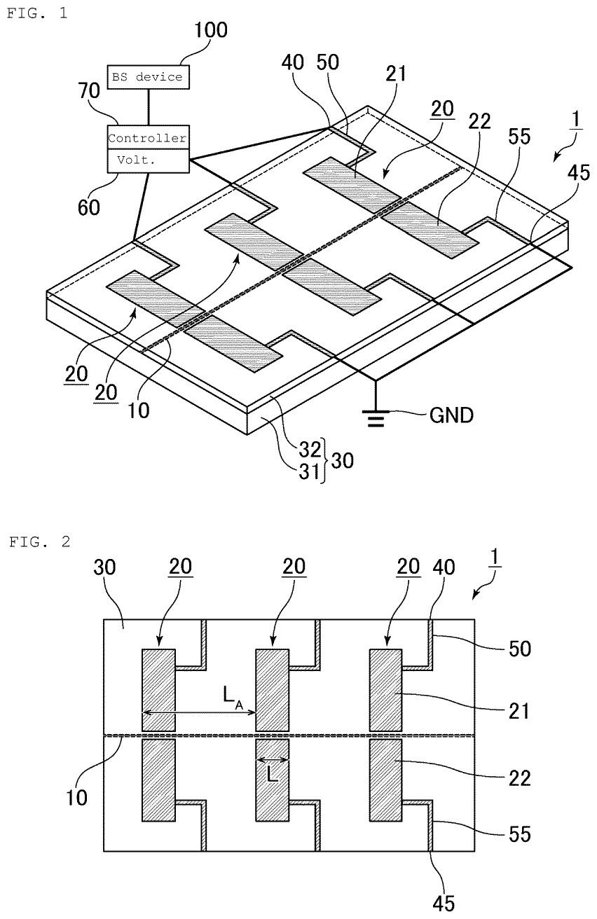

The present disclosure is directed to providing an antenna-integrated electro-optic modulator capable of actively controlling a beam direction of a radio signal received by an antenna electrode. In particular, as used herein, the term “interface” refers to a combination of one or more hardware structures configured to facilitate the delivery, routing, or application of DC bias voltages to the plurality of antenna electrodes. The interface serves as a physical and electrical bridge between a voltage source and the antenna electrodes to enable the control of the reception direction. In one embodiment, as illustrated in FIG. 1, the interface includes “circuitry” (e.g., a voltage circuit or a controller) configured to actively generate or apply the voltages. Such circuitry may be implemented as one or more processors, ASICs (Application Specific Integrated Circuits), FPGAs (Field Programmable Gate Arrays), conventional circuitry, and/or combinations thereof. In another embodiment, as illustrated in FIG. 2, the interface includes a passive arrangement of “external connection terminals” and “wirings” configured to receive voltages from an external source and conduct them to the antenna electrodes. The term “interface” is intended to encompass both integrated active components and external passive connection structures, as well as any combination thereof.

Hereinafter, an antenna-integrated electro-optic modulator of the present disclosure will be described. The present disclosure is not limited to a configuration below, and may be modified as appropriate without departing from the gist of the present disclosure. Further, a combination of a plurality of individual configurations described below is also the present disclosure.

The antenna-integrated electro-optic modulator of the present disclosure is used in, for example, a wireless communication system.

In a wireless communication system, a technique called radio over fiber (RoF) for transmitting waveform information of a radio signal by an optical fiber is employed. As RoF, digital radio over fiber (D-RoF) and analog radio over fiber (A-RoF) are known.

D-RoF is a technique of converting waveform information of a radio signal into a digital signal and then transmitting the digital signal through an optical fiber. However, it is considered that D-RoF has a problem below.
(1) Since transmission capacity at the time of transmitting a digital signal is large, optical communication cannot catch up with next-generation large-capacity communication.
(2) Since various types of processing such as digital signal processing (DSP) are performed by a radio unit (RU), when the number of RUs is increased to realize radio communication in a high frequency band, the cost increases accordingly.
(3) Power consumption related to processing in an RU is large.

On the other hand, A-RoF is a technique in which waveform information of a radio signal is directly transmitted as an analog signal through an optical fiber. In A-RoF, unlike D-RoF, it is not necessary to perform various types of processing in an RU, for example, it is not necessary to perform DSP. For this reason, in order to solve the above problem considered in D-RoF, it is considered to employ A-RoF instead of D-ROF to integrate functions of an RU into a distributed unit (DU) or a centralized unit (CU), so as to reduce the cost and power consumption related to the RU while simplifying the RU.

The antenna-integrated electro-optic modulator of the present disclosure may be used in a wireless communication system employing A-RoF. More specifically, the antenna-integrated electro-optic modulator of the present disclosure may be used as a modulator that modulates an optical signal by an electro-optic effect by using a radio signal received by an antenna in an RU in order to obtain an analog signal transmitted through an optical fiber from the RU to a DU.

The drawings illustrated below are schematic views, and dimensions, scales of aspect ratios, and the like may be different from those of actual products. In the drawings, the same or corresponding parts are denoted by the same reference numerals. In each drawing, the same elements are denoted by the same reference numerals, and redundant description will be omitted.

In the present specification, the terms indicating the relationship between elements (for example, “vertical”, “parallel”, and “orthogonal”) and the terms indicating the shape of an element are not expressions indicating only a strict meaning, but are expressions meaning to include a substantially equivalent range, for example, a difference of about several %.

FIG. 1 is a schematic view illustrating an example of an antenna-integrated electro-optic modulator of the present disclosure. FIG. 2 is a plan view illustrating a part of the antenna-integrated electro-optic modulator illustrated in FIG. 1.

An antenna-integrated electro-optic modulator 1 illustrated in FIGS. 1 and 2 includes an optical waveguide 10 that transmits an optical signal and a plurality of antenna electrodes 20 that receive a radio signal for modulating the optical signal by an electro-optic effect. The antenna-integrated electro-optic modulator 1 may further include a substrate 30.

For example, laser light to be an optical signal is transmitted to the optical waveguide 10 via an optical fiber. The laser light is a light wave serving as a carrier, and for example, a laser having a wavelength of 1.55 μm is used.

In the example illustrated in FIGS. 1 and 2, one optical waveguide 10 is provided in the antenna-integrated electro-optic modulator 1. The number of the optical waveguides 10 is not particularly limited, and may be one or may be two or more.

In the example illustrated in FIGS. 1 and 2, the optical waveguide 10 extends linearly when viewed from a main surface side of the substrate 30, but may extend in a bent manner when viewed from the main surface side of the substrate 30. In this case, the optical waveguide 10 may be bent in a polygonal line shape or may be bent in a curved line shape.

The optical waveguide 10 may be composed of an electro-optic material.

When an electric field is applied, the electro-optic material exhibits an electro-optic effect that causes a change in phase of light in addition to a change in refractive index with respect to light.

The optical waveguide 10 may include, as the electro-optic material, of an electro-optic polymer containing an electro-optic molecule.

The electro-optic polymer is a polymer capable of exhibiting an electro-optic effect.

Examples of the electro-optic polymer include a guest-host type electro-optic polymer in which a matrix polymer and an electro-optic molecule are mixed, a side-chain type electro-optic polymer in which an electro-optic molecule is covalently bonded to a side chain of a base polymer, a main-chain type electro-optic polymer in which electro-optic molecules are covalently bonded in a main chain of a base polymer, a crosslink type electro-optic polymer in which crosslinking occurs between matrix polymers or between base polymers, or between a matrix polymer or a base polymer and an electro-optic molecule and the like, and a molecular-glass type electro-optic polymer.

The matrix polymer is a polymer as a base of the electro-optic polymer. The matrix polymers include an organic polymer as a host of a guest-host type electro-optic polymer.

The base polymer is a polymer serving as the backbone of the electro-optic polymer. The base polymer includes an organic polymer to be a main chain of a polymer in a side-chain type electro-optic polymer, a main-chain type electro-optic polymer, or a crosslink-type electro-optic polymer.

As the matrix polymer and the base polymer, a transparent polymer that does not cause scattering may be used as an optical material, and examples of the matrix polymer and the base polymer include a (meth)acrylate-based polymer, polyamide, polyimide, polycarbonate, poly(dicyclopentanyl methacrylate), poly(adamantyl methacrylate), a cycloolefin polymer, a cycloolefin copolymer, polynorbornene, polystyrene, polyethylene, polymethylpentene, polypropylene, polyvinyl alcohol, polyethylene terephthalate, polysulfone, polyether sulfone, polyester, polyolefin, polyphenylene sulfide, polyurea, silicon-based resin, epoxy-based resin, and fluororesin. As the matrix polymer and the base polymer, one kind of these organic polymers may be used alone or a plurality of kinds of these organic polymers may be used in combination.

The electro-optic molecule is a compound capable of exhibiting an electro-optic effect.

The electro-optic molecule may be a compound having a conjugated chemical structure and further having an electron-donating group and an electron-withdrawing group in a molecule.

Examples of the conjugated chemical structure include aromatic compounds such as benzene, naphthalene, anthracene, perylene, biphenyl, indene, and stilbene, heterocyclic compounds such as furan, pyran, pyrrole, imidazole, pyrazole, thiophene, thiazole, pyridine, pyridazine, pyrimidine, pyrazine, quinoline, and coumarin, and a compound in which these compounds are bonded to each other by a carbon-carbon unsaturated bond or a nitrogen-nitrogen unsaturated bond.

Examples of the electron-donating group include a thioether group, an allyloxy group, an alkoxy group, and an amino group which may be substituted with an alkyl group, an aryl group, or an acyl group.

Examples of the electron-withdrawing group include a nitro group, a cyano group, a dicyanovinyl group, a tricyanovinyl group, a halogen atom, a carbonyl group, a sulfonyl group, perfluoroalkyl, tricyanovinylfuran, and tricyanofuran.

The optical waveguide 10 may be composed of, for example, a ferroelectric material having optical anisotropy such as lithium niobate (LiNbO₃), lithium tantalate (LiTaO₃), or potassium titanyl phosphate (KTiOPO₄: KTP) as the electro-optic material.

Each of a plurality of antenna electrodes 20 receives a radio signal for modulating an optical signal transmitted through the optical waveguide 10 by an electro-optic effect.

The antenna electrode 20 may be provided on a main surface of the substrate 30.

In the example illustrated in FIGS. 1 and 2, three antenna electrodes 20 are provided. The number of the antenna electrodes 20 is not limited to three as long as the number is more than one, and may be two or four or more.

The antenna electrodes 20 may be arranged along the optical waveguide 10, e.g., at equal intervals along the optical waveguide 10. For example, pitches (a length denoted by L_{A} in FIG. 2, i.e., pitch of the electrode array along the propagation axis of the waveguide) of the antenna electrodes 20 may be equal in all the antenna electrodes 20. Note that “equal intervals” include not only a case where the pitches L_{A} of the antenna electrodes 20 are completely equal, but also a case where the pitches L_{A} are substantially equal, for example, including differences of about several %.

The shape of the antenna electrode 20 is not particularly limited, and may be partially or entirely different, but may be the same. For example, in all the antenna electrodes 20, the lengths (a length denoted by L in FIG. 2) of the antenna electrodes 20 are may be equal. The length L of the antenna electrode 20 here means a length in a direction in which the optical waveguide 10 extends. Note that “equal length” includes not only a case where the lengths L of the antenna electrodes 20 are completely equal, but also a case where the lengths L are substantially equal, for example, including differences of about several %. As illustrated in FIG. 2, all the antenna electrodes 20 may be equal in a length in a direction perpendicular to the direction in which the optical waveguide 10 extends, as well as the length in the direction in which the optical waveguide 10 extends.

As illustrated in FIGS. 1 and 2, each antenna electrode 20 includes, for example, two plane electrodes 21 and 22 adjacent to each other in the direction perpendicular to the direction in which the optical waveguide 10 extends, and a gap is formed between the plane electrodes 21 and 22 (a center of the antenna electrode 20 in FIGS. 1 and 2). For example, the plane electrodes 21 and 22 both have a quadrangular shape and are arranged symmetrically with the gap interposed therebetween. A distance of the gap is, for example, 5 μm. As the distance of the gap is shorter, an electric field in a vicinity of a side where the plane electrodes 21 and 22 face each other can be intensified.

Examples of a constituent material of the antenna electrode 20 include gold, silver, copper, tin, chromium, aluminum, titanium, an alloy containing at least one kind of these metals, and an oxide (for example, indium tin oxide, indium zinc oxide, aluminum-doped zinc oxide, and the like) containing at least one kind of these metals. The constituent materials of the antenna electrodes 20 may be the same as or different from each other.

The optical waveguide 10 may be provided inside the substrate 30 so as to extend along the main surface of the substrate 30.

The substrate 30 may include only one layer or may include a plurality of layers.

For example, the substrate 30 may include a supporting substrate 31 and an electro-optic layer 32 in order toward the antenna electrode 20 side. In this case, the optical waveguide 10 may be between the supporting substrate 31 and the electro-optic layer 32. In addition, the antenna electrode 20 may be on the surface of the electro-optic layer 32 opposite to the supporting substrate 31.

For example, a constituent material of the supporting substrate 31 may be an inorganic material such as silicon or glass, or may be an organic material such as a cycloolefin polymer or a cycloolefin copolymer. The supporting substrate 31 may contain only one kind or a plurality of kinds of these materials.

In the supporting substrate 31, at least a main surface on the antenna electrode 20 side may be composed of a material having a low dielectric constant such as a cycloolefin polymer. In this case, the optical waveguide 10 may be on the main surface of the supporting substrate 31 on the antenna electrode 20 side.

The supporting substrate 31 may include only one layer or may include a plurality of layers.

Examples of a constituent material of the electro-optic layer 32 include, for example, a ferroelectric material having optical anisotropy such as lithium niobate (LiNbO₃), lithium tantalate (LiTaO₃), or potassium titanyl phosphate (KTiOPO₄: KTP).

The electro-optic layer 32 may include only one layer or may include a plurality of layers.

The antenna-integrated electro-optic modulator 1 may further include a ground electrode.

The ground electrode may be provided on a main surface of the substrate 30 opposite to the main surface on which the plurality of antenna electrodes 20 is provided, or may be provided inside the substrate 30. In either case, the optical waveguide 10 is located between the ground electrode and the antenna electrode 20.

Examples of a constituent material of the ground electrode include gold, silver, copper, tin, chromium, aluminum, titanium, an alloy containing at least one kind of these metals, and an oxide (for example, indium tin oxide, indium zinc oxide, aluminum-doped zinc oxide, and the like) containing at least one kind of these metals. The constituent material of the ground electrode may be the same as or different from the constituent material of the antenna electrode 20.

The antenna-integrated electro-optic modulator 1 functions as a modulator that modulates an optical signal by an electro-optic effect by using a radio signal received by the antenna electrode 20 in a manner described below.

In the antenna-integrated electro-optic modulator 1, an optical signal is transmitted to the optical waveguide 10. On the other hand, each of the plurality of antenna electrodes 20 receives a radio signal. At this time, an electric field is increased by a resonance phenomenon generated in the antenna electrode 20, and an electro-optic effect is generated in the optical waveguide 10 passing through a place where the electric field is generated. When the electro-optic effect is generated in the optical waveguide 10, a refractive index of the optical waveguide 10 with respect to an optical signal transmitted to the optical waveguide 10 changes, so that a phase of the optical signal changes according to the magnitude of the electric field. In this manner, the antenna-integrated electro-optic modulator 1 modulates an optical signal transmitted to the optical waveguide 10 by an electro-optic effect by using a radio signal received by a plurality of the antenna electrodes 20. That is, the antenna-integrated electro-optic modulator 1 directly superimposes a radio signal received by a plurality of the antenna electrodes 20 on an optical signal transmitted to the optical waveguide 10 by using the electro-optic effect.

In the conventional configuration, since the beam direction of the radio signal received by the antenna electrode 20 is completely determined by the arrangement of the pitch, length, and the like of the antenna electrode 20, it is impossible to change the beam direction.

On the other hand, in the antenna-integrated electro-optic modulator 1, DC voltages (bias voltages) having different values are applied to the antenna electrodes 20. Since the application of the DC voltage causes a change in the phase of the optical signal, the beam direction of the radio signal received by the antenna electrode 20 can be changed by changing the value of the DC voltage applied to each antenna electrode 20. Therefore, the beam direction can be actively controlled.

Specifically, as illustrated in FIGS. 1 and 2, the antenna-integrated electro-optic modulator 1 includes a plurality of external connection terminals 40 for receiving different DC voltages, and a plurality of wirings 50 for connecting the external connection terminals 40 and the antenna electrodes 20.

In the example illustrated in FIG. 1, the antenna-integrated electro-optic modulator 1 includes a voltage circuit 60 for applying different DC voltages to the respective antenna electrodes 20. The voltage circuit 60 is connected to the external connection terminal 40, and the voltage circuit 60 and the antenna electrodes 20 are connected by a plurality of the wirings 50.

As illustrated in FIG. 1, the antenna-integrated electro-optic modulator 1 may further include a controller 70 for receiving a control optical signal and controlling the voltage circuit 60. For example, the controller 70 receives a control optical signal from the RU of a base station device 100.

In A-RoF, it is desired to remotely control a steering angle of the beam from the RU, but the above configuration enables remote control.

Further, in the above configuration, since it is only necessary to add one optical fiber for transmitting the control optical signal when receiving beams in a plurality of directions, the number of optical fibers can be suppressed.

In the example illustrated in FIGS. 1 and 2, the antenna-integrated electro-optic modulator 1 further includes a plurality of external connection terminals 45 for connection to a ground GND, and a plurality of wirings 55 for connecting the external connection terminals 45 and the ground GND.

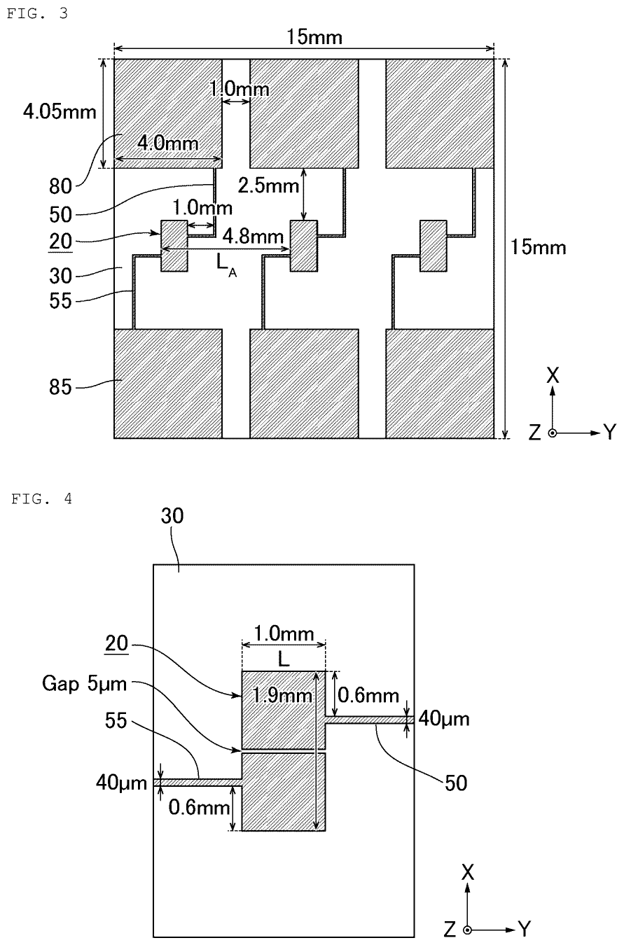

As illustrated in FIGS. 1 and 2, when each antenna electrode 20 is constituted by the plane electrodes 21 and 22, the voltage circuit 60 is connected to the external connection terminal 40 in order to apply different DC voltages to the plane electrodes 21, and a plurality of the wirings 50 connect the voltage circuit 60 and the plane electrodes 21. On the other hand, the ground GND is connected to the external connection terminal 45, and a plurality of the wirings 55 connects the ground GND and the plane electrodes 22. The wirings 50 and 55 may be high impedance lines such that an electric field received by the antenna electrode 20 does not flow into a ground electrode 85 (see FIG. 3).

Each of the plane electrodes 21 and 22 constituting the antenna electrode 20 is provided on the main surface of the substrate 30, and the plane electrodes 21 and 22 may be on the same plane, but may be located on different planes from each other. For example, the plane electrode 21 may be provided on one main surface of the substrate 30, and the plane electrode 22 may be provided inside the substrate 30 or on the other main surface of the substrate 30.

The voltage circuit 60 includes, for example, a plurality of voltage dividing circuits capable of changing a resistance value by a plurality of switch elements.

The controller 70 includes, for example, a light receiving element (such as a photodiode) that converts a control optical signal into a current signal, a current-voltage conversion element that converts the current signal into a voltage signal, and an integrated circuit (IC) that controls a DC voltage applied to each antenna electrode 20.

### EXAMPLES

Hereinafter, examples will be described in which the antenna-integrated electro-optic modulator of the present disclosure is more specifically disclosed. Note that the present disclosure is not limited only to these examples. For example, while various embodiments describe operation at a frequency of 28 GHz, the antenna-integrated electro-optic modulator is configured for operation across the Millimeter Wave (mmWave) spectrum, including but not limited to frequencies between 24 GHZ and 100 GHz. The physical dimensions of the antenna electrodes and the pitch are specifically scaled to match the wavelength of the target radio signal frequency within this range.

In the following examples, the number of antenna electrodes is six, and a phase difference between the antenna electrodes is π/3.

FIG. 3 is a plan view schematically illustrating an example of electrode arrangement in an antenna-integrated electro-optic modulator according to an example within the scope of the present disclosure. FIG. 4 is an enlarged view of the antenna electrode in FIG. 3.

As illustrated in FIG. 3, the antenna electrodes 20 and the DC voltage application electrodes 80 are connected by the wirings 50, respectively, and the antenna electrodes 20 and the ground electrodes 85 are connected by the wirings 55, respectively. While described in some embodiments as a common ground potential (GND), the ground electrode 85 may be formed as a conductive layer on the supporting substrate 80 or as a distinct plane electrode disposed parallel to the main surface of the substrate. The ground electrode 85 is configured to cooperate with the antenna electrodes 20 to establish an electric field across the electro-optic layer, thereby inducing the phase shift in the optical signal.

In FIG. 3, the pitch L_{A} of the antenna electrodes 20 is 4.8 mm.

In FIG. 4, the length L of the antenna electrode 20 in a direction (Y direction) in which an optical waveguide extends is 1.0 mm, a length of the antenna electrode 20 in a direction (X direction) perpendicular to the direction in which the optical waveguide extends is 1.9 mm, a gap distance is 5 μm, widths of the wiring lines 50 and 55 each are 40 μm, and a distance from an end surface of the antenna electrode 20 to the wiring line 50 or 55 is 0.6 mm.

Other conditions are shown below.
Light refractive index of optical waveguide: 2.2
Overlap constant Γ indicating degree of overlap between resonance electric field generated by electrode and optical electric field in optical waveguide: 0.8
Electro-optic constant r₃₃: 33 μm/V
Light wavelength: 1550 nm (1.55 μm)
Transmission power: 0 dBm
Transmission antenna gain: 16.5 dBi
Communication distance: 1 m
Intensity of increase in electric field generated by resonance of antenna electrode: 800
Radio frequency: 28 GHZ

Here, the total amount of phase change of the optical signal by the N antenna electrodes is obtained by executing the following integration.

$$Δφ = - {k}_{op} A {\sum }_{s = 0}^{N - 1} {\int }_{{sL}_{A}}^{{sL}_{A} + L} sin ( {k}_{m} {sL}_{A} sin θ - {ω}_{m} t + {δφ}_{s} ) dx \qquad [ Mathematical Formula 1 ]$$

$$A = \frac{{n}_{0}^{3} {rE}_{0} Γ}{2} \qquad [ Mathematical Formula 2 ]$$

In the above formula, kₘ represents a wave number of a radio wave, kₒₚ represents a wave number of light, s represents an antenna number, r represents an electro-optic coefficient, Γ represents an overlap coefficient, and n₀ represents a refractive index of light. As the refractive index in this case, a group refractive index is considered.

Further, δφₛ is a phase delay amount necessary for each antenna electrode, and has a different value for each antenna electrode. A “target incident angle” refers to the specific spatial direction from which the plurality of antenna electrodes are configured to have maximum reception sensitivity. By applying a non-uniform distribution of DC bias voltages across the array of antenna electrodes, the processing circuitry introduces a localized phase delay dos that electronically steers the antenna beam. This allows the modulator to transition the reception direction from a first incident angle to a second incident angle without requiring physical movement of the device. The application of the non-uniform DC bias voltages affects a physical change in the phase-shifting characteristics of the electro-optic layer, thereby providing a technical solution to the hardware-based problem of beam steering in high-capacity Radio over Fiber (RoF) systems.

In the present example in which the number of antenna electrodes is six and the phase difference between the antenna electrodes is π/3, δφₛ=0, π/3, 2π/3, π, 4π/3, and 5π/3. The phase is set based on an antenna of s=0.

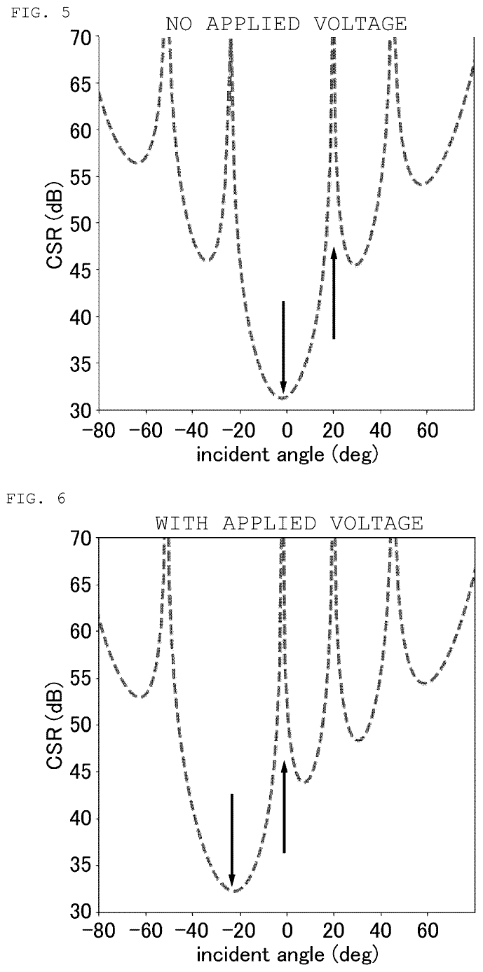

FIG. 5 is an example of angle dependence of the reception sensitivity in a case where no DC voltage is applied to the antenna electrode. FIG. 6 is an example of the angle dependence of the reception sensitivity in a case where a DC voltage is applied to the antenna electrode. In FIGS. 5 and 6, a horizontal axis represents an incident angle of the radio wave, and indicates an angle from a Z axis on a ZY plane illustrated in FIG. 3. On the other hand, a vertical axis represents a carrier-to-sideband ratio (CSR) indicating power of a first-order sideband relative to power of an optical carrier wave. It can be said that the smaller the CSR, the smaller a power difference between the optical carrier wave and the sideband, and thus the higher the sensitivity.

From FIGS. 5 and 6, it can be seen that, by applying DC voltages of different values to the antenna electrodes, a point (downward arrow) of maximum reception sensitivity of a main lobe near an incident angle of 0 degrees changes to near −20 degrees. From FIGS. 5 and 6, it can be seen that a position (upward arrow) of a null point of the reception sensitivity also changes by the application of the DC voltage.

Note that the change in phase due to the DC voltage with respect to light can be expressed by the following formula.

$$\overline{A} ( t ) = {A}_{0} {e}^{{i ω}_{0} t} {e}^{- {i ω}_{0} Δ nL / c} \qquad [ Mathematical Formula 3 ]$$

$$Δ n = - \frac{1}{2} {n}_{0}^{3} rE \qquad [ Mathematical Formula 4 ]$$

$$\vert {δφ}_{s} \vert = 0.5 \times {}^{I} ( {2.2}^{3} \times 30 \times {10}^{- 12} ) \times {}^{II} ( \frac{10}{5 \times {10}^{- 6}} ) \times {}^{III} ( 1 \times {10}^{- 3} ) \times {}^{IV} ( \frac{2 π}{1.55 \times {10}^{- 6}} ) \approx 1.3 [ rad ] \approx π / 2.4 \qquad [ Mathematical Formula 5 ]$$

In the above formula, a portion I corresponds to n₀³r₃₃ of lithium niobate constituting the optical waveguide, a portion II corresponds to a DC electric field calculated assuming that a DC voltage of 10 V is applied to a gap of 5 μm installed in the electrode, a portion III corresponds to a length of 1 mm of the antenna electrode, and a portion IV corresponds to the wave number of light.

From the above, it is considered that a phase difference of π/3 can be created by applying a DC voltage of about 10 V to the antenna electrode. A phase difference of 5π/3, which is the maximum value, requires a DC voltage of about 50 V, which is 5 times that amount, but is a voltage that can be output by a commercially available three-terminal regulator. In addition, by increasing the length of the antenna electrode, it is possible to create a phase difference even with a smaller DC voltage.

The following content is disclosed in the present specification.

<1>

An antenna-integrated electro-optic modulator including:
an optical waveguide that transmits an optical signal;
a plurality of antenna electrodes that receive a radio signal for modulating the optical signal by an electro-optic effect; and
a voltage circuit for applying different DC voltages to the antenna electrodes.
   <2>

The antenna-integrated electro-optic modulator of <1>, further including a controller for receiving a control optical signal and controlling the voltage circuit.

<3>

The antenna-integrated electro-optic modulator according to <1> or <2>, further including a plurality of wirings that connect the voltage circuit and the antenna electrodes.

<4>

An antenna-integrated electro-optic modulator including:
an optical waveguide that transmits an optical signal;
a plurality of antenna electrodes that receive a radio signal for modulating the optical signal by an electro-optic effect;
a plurality of external connection terminals for receiving different DC voltages; and
a plurality of wirings that connect the external connection terminals and the antenna electrodes.
   <5>

The antenna-integrated electro-optic modulator according to any one of <1> to <4>, wherein the antenna electrodes are arranged at equal intervals along the optical waveguide.

<6>

The antenna-integrated electro-optic modulator according to any one of <1> to <5>, wherein shapes of the antenna electrodes are the same as each other.

<7>

The antenna-integrated electro-optic modulator according to any one of <1> to <6>, further including
a substrate, wherein
the optical waveguide is provided inside the substrate so as to extend along a main surface of the substrate.
   <8>

The antenna-integrated electro-optic modulator according to <7>, wherein the antenna electrode is provided on the main surface of the substrate.

<9>

The antenna-integrated electro-optic modulator according to any one of <1> to <8>, wherein the optical waveguide includes, as an electro-optic material, an electro-optic polymer containing an electro-optic molecule.

### DESCRIPTION OF REFERENCE SYMBOLS

1: Antenna-integrated electro-optic modulator
10: Optical waveguide
20: Antenna electrode
21, 22: Plane electrode
30: Substrate
31: Supporting substrate
32: Electro-optic layer
40, 45: External connection terminal
50, 55: Wiring
60: Voltage circuit
70: Controller
80: DC voltage application electrode
85: Ground electrode
100: Base station device
GND: Ground
L_{A}: Pitch of antenna electrode
L: Length of antenna electrode

1. An antenna-integrated electro-optic modulator comprising:
an optical waveguide configured to transmit an optical signal;
a plurality of antenna electrodes disposed along the optical waveguide and configured to receive a radio signal to modulate the optical signal by an electro-optic effect; and
an interface configured to provide different DC bias voltages to individual antenna electrodes of the plurality of antenna electrodes to control a reception direction of the radio signal.

2. The antenna-integrated electro-optic modulator according to claim 1, wherein the interface includes circuitry configured to apply the different DC bias voltages.

3. The antenna-integrated electro-optic modulator of claim 2, wherein the circuitry is further configured to receive a control optical signal and control the application of different DC bias voltages.

4. The antenna-integrated electro-optic modulator according to claim 2, further comprising a plurality of wirings that connect the circuitry and the antenna electrodes.

5. The antenna-integrated electro-optic modulator according to claim 1, wherein the interface includes a plurality of external connection terminals configured to receive the different DC voltages; and
a plurality of wirings that connect the external connection terminals and the antenna electrodes.

6. The antenna-integrated electro-optic modulator according to claim 1, wherein the antenna electrodes are arranged at equal intervals along the optical waveguide.

7. The antenna-integrated electro-optic modulator according to claim 1, wherein shapes of the antenna electrodes are the same as each other.

8. The antenna-integrated electro-optic modulator according to claim 1, further comprising
a substrate, wherein
the optical waveguide is provided inside the substrate so as to extend along a main surface of the substrate.

9. The antenna-integrated electro-optic modulator according to claim 1, wherein the antenna electrode is provided on the main surface of the substrate.

10. The antenna-integrated electro-optic modulator according to claim 1, wherein the optical waveguide includes, as an electro-optic material, an electro-optic polymer containing an electro-optic molecule.

11. The modulator according to claim 1, further comprising a ground electrode disposed such that the optical waveguide is located between the ground electrode and the plurality of antenna electrodes.

12. A wireless communication system, comprising:
the antenna-integrated electro-optic modulator of claim 1;
an optical source configured to provide the optical signal to the optical waveguide; and
a base station processor configured to output a control signal to the voltage application circuitry to adjust the reception direction.

13. The wireless communication system according claim 12, further comprising an optical fiber configured to transmit the control signal as an analog radio-over-fiber (A-RoF) signal.

14. A method for controlling a reception direction of an antenna-integrated electro-optic modulator, the method comprising:
transmitting an optical signal through an optical waveguide;
receiving a radio signal at a plurality of antenna electrodes; and
applying a plurality of different DC voltages to the plurality of antenna electrodes to induce a phase difference in the optical signal, wherein the plurality of different DC voltages are selected to set the reception direction of the plurality of antenna electrodes to a target incident angle.

15. The method according to claim 14, further comprising receiving a control optical signal from a base station device and adjusting the plurality of different DC voltages based on the control optical signal.
